(19) United States
(12) Patent Application Publication
(10) Pub. No.: US 2025/0020757 A1
(43) Pub. Date: Jan. 16, 2025

(54) ANALYZING LOCATION MEASUREMENT ACCURACY

(71) Applicant: Lenovo (Singapore) Pte. Ltd., New Tech Park (SG)

(72) Inventors: Dimitrios Karampatsis, Ruislip (GB); Emmanouil Pateromichelakis, Viersen (DE)

(21) Appl. No.: 18/716,084

(22) PCT Filed: Jan. 14, 2022
(86) PCT No.: PCT/EP2022/050814

§ 371 Date: Jun. 3, 2024

(30) Foreign Application Priority Data
Dec. 3, 2021 (GR) 20210100841

(51) Int. Cl. G01S 5/02; H04W 64/00

(52) U.S. Cl. CPC G01S 5/0244; H04W 64/006

(57) ABSTRACT

Apparatuses, methods, and systems are disclosed for analyzing location measurement accuracy. One method includes receiving a first request to provide statistics, predictions, or a combination thereof corresponding to an accuracy of a location measurement for at least one user equipment. The method includes determining to retrieve, from a location management function, information corresponding to an accuracy of a measured location. The method includes sending a second request to retrieve measurement accuracy for a location measurement. The method includes deriving analytics for location measurement accuracy based on the measurement accuracy for the location measurement.

### FIELD

The subject matter disclosed herein relates generally to wireless communications and more particularly relates to analyzing location measurement accuracy.

### BACKGROUND

In certain wireless communications networks, a location of a user equipment may be determined. The location may not be determined accurately.

### BRIEF SUMMARY

Methods for analyzing location measurement accuracy are disclosed. Apparatuses and systems also perform the functions of the methods. One embodiment of a method includes receiving, at a network data analytics function, a first request to provide statistics, predictions, or a combination thereof corresponding to an accuracy of a location measurement for at least one user equipment. In some embodiments, the method includes determining to retrieve, from a location management function, information corresponding to an accuracy of a measured location. In certain embodiments, the method includes sending a second request to retrieve measurement accuracy for a location measurement. In various embodiments, the method includes deriving analytics for location measurement accuracy based on the measurement accuracy for the location measurement.

One apparatus for analyzing location measurement accuracy includes a network data analytics function. In some embodiments, the apparatus includes a receiver that receives a first request to provide statistics, predictions, or a combination thereof corresponding to an accuracy of a location measurement for at least one user equipment. In various embodiments, the apparatus includes a processor that: determines to retrieve, from a location management function, information corresponding to an accuracy of a measured location; sends a second request to retrieve measurement accuracy for a location measurement; and derives analytics for location measurement accuracy based on the measurement accuracy for the location measurement.

Another embodiment of a method for analyzing location measurement accuracy includes receiving, at a location management function, a request to providing information corresponding to an accuracy of a location measurement. The request includes a target user equipment, a group of user equipments, a target area, a specific period of time, or some combination thereof. In some embodiments, the method includes determining to report information in response to the location measurement being based on requests from location clients. In certain embodiments, the method includes reporting location measurement accuracy data to a network data analytics function.

Another apparatus for analyzing location measurement accuracy includes a location management function. In some embodiments, the apparatus includes a receiver that receives a request to providing information corresponding to an accuracy of a location measurement. The request includes a target user equipment, a group of user equipments, a target area, a specific period of time, or some combination thereof. In various embodiments, the apparatus includes a processor that: determines to report information in response to the location measurement being based on requests from location clients; and reports location measurement accuracy data to a network data analytics function.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for analyzing location measurement accuracy;

FIG. 2 is a schematic block diagram illustrating one embodiment of an apparatus that may be used for analyzing location measurement accuracy;

FIG. 3 is a schematic block diagram illustrating one embodiment of an apparatus that may be used for analyzing location measurement accuracy;

FIG. 4 is a schematic block diagram illustrating one embodiment of a system for supporting location services;

FIG. 5 is a schematic block diagram illustrating one embodiment of a system for analyzing location measurement accuracy;

FIG. 6 is a schematic block diagram illustrating another embodiment of a system for analyzing location measurement accuracy;

FIG. 7 is a flow chart diagram illustrating one embodiment of a method for analyzing location measurement accuracy; and

FIG. 8 is a flow chart diagram illustrating another embodiment of a method for analyzing location measurement accuracy.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

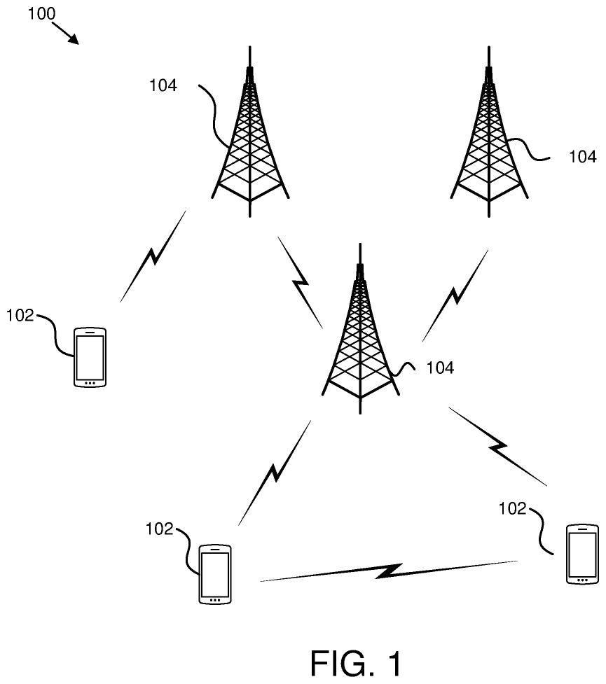

FIG. 1 depicts an embodiment of a wireless communication system 100 for analyzing location measurement accuracy. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a network data analytics function, a first request to provide statistics, predictions, or a combination thereof corresponding to an accuracy of a location measurement for at least one user equipment. In some embodiments, the first request may target a specific area for providing accuracy of location measurements for any user equipment reporting location measurements in the target area. In some embodiments, the network unit 104 may determine to retrieve, from a location management function, information corresponding to an accuracy of a measured location. In certain embodiments, the network unit 104 may send a second request to retrieve measurement accuracy for a location measurement. In various embodiments, the network unit 104 may derive analytics for location measurement accuracy based on the measurement accuracy for the location measurement. Accordingly, the network unit 104 may be used for analyzing location measurement accuracy.

In certain embodiments, a network unit 104 may receive, at a location management function, a request to providing information corresponding to an accuracy of a location measurement. The request includes a target user equipment, a group of user equipments, a target area, any user equipment, a specific period of time, or some combination thereof. In some embodiments, the network unit 104 may determine to report information in response to the location measurement being based on requests from location clients. In certain embodiments, the network unit 104 may report location measurement accuracy data to a network data analytics function. Accordingly, the network unit 104 may be used for analyzing location measurement accuracy.

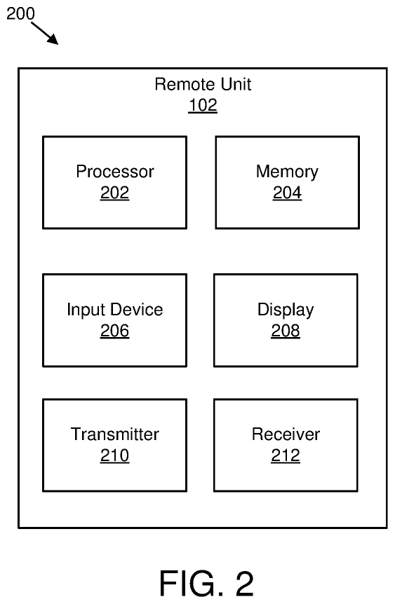

FIG. 2 depicts one embodiment of an apparatus 200 that may be used for analyzing location measurement accuracy. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

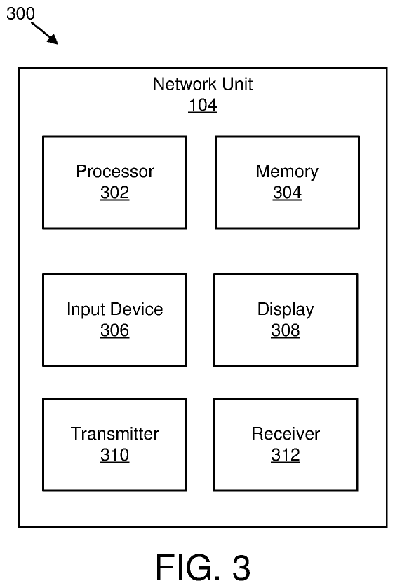

FIG. 3 depicts one embodiment of an apparatus 300 that may be used for analyzing location measurement accuracy. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives a first request to provide statistics, predictions, or a combination thereof corresponding to an accuracy of a location measurement for at least one user equipment. In various embodiments, the processor 302: determines to retrieve, from a location management function, information corresponding to an accuracy of a measured location; sends a second request to retrieve measurement accuracy for a location measurement; and derives analytics for location measurement accuracy based on the measurement accuracy for the location measurement.

In some embodiments, the receiver 312 receives a request to providing information corresponding to an accuracy of a location measurement. The request includes a target user equipment, a group of user equipments, any user equipment, a target area, a specific period of time, or some combination thereof. In various embodiments, the processor 302: determines to report information in response to the location measurement being based on requests from location clients; and reports location measurement accuracy data to a network data analytics function.

In certain embodiments, if a consumer requests analytics from a network data analytics function (“NWDAF”), the consumer may include a target area, a target user equipment (“UE”), and/or group of UEs in the request. In such embodiments, the NWDAF may derive analytics by collecting data and/or events from one or more network functions ensuring the data is from the target area requested or involve the target UEs. The analytics may be derived taking into account a static location of UEs based on an AMF determining a UE entering or leaving a specific area of interest with a granularity of one or more tracking areas or cell identifiers (“IDs”).

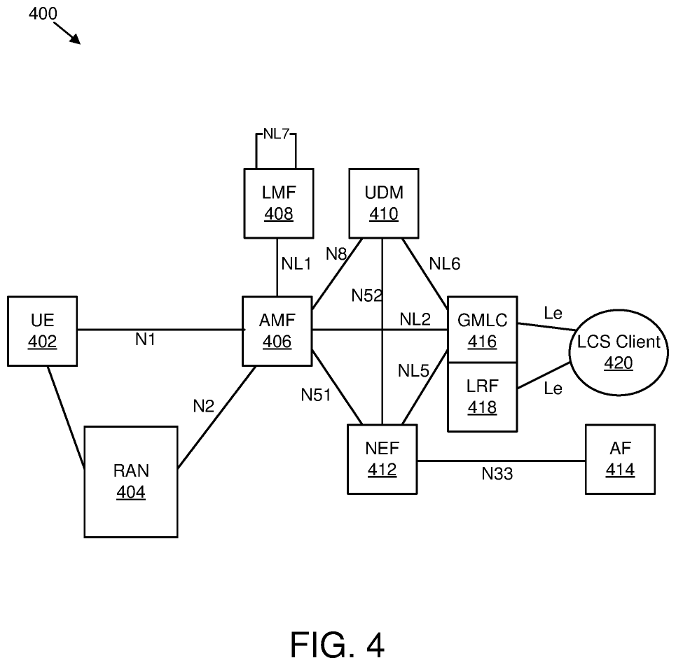

In some embodiments, an architecture for supporting location services in a fifth generation system (“5GS”) is as shown in FIG. 4.

FIG. 4 is a schematic block diagram illustrating one embodiment of a system 400 for supporting location services. The system 400 includes a UE 402 and a number of network units 104. The network units 104 include a RAN 404, an AMF 406, a location management function (“LMF”) 408, a UDM 410, a network exposure function (“NEF”) 412, an application function (“AF”) 414, a gateway mobile location center (“GMLC”) 416, a location retrieval function (“LRF”) 418, and a location services (“LCS”) client 420.

In various embodiments, a location request is sent from the LCS client 420 and is received by the GMLC 416. The GMLC 416 is responsible to validate a request and forward the request to the AMF 406 serving the UEs 402 whose location is requested. The AMF 406 selects the LMF 408 for collection location events from target UEs 402. The LMF 408 manages the overall coordination and scheduling of resources required for the location for the UE 402. The LMF 408 receives location requests for the target UE 402 from the serving AMF 406 using the Nlmf interface. The LMF 408 interacts with the UE 402 or the RAN 404 according to the location method used to exchange location information applicable to the UE 402. The UE 402 and/or the RAN 404 and the LMF 408 exchanges positioning information via control plane signaling by supporting an LTE positioning protocol (“LPP”) if the UE 402 is served by an LTE access or NR positioning protocol (“NRPPa”) if the UE served by NR access.

In certain embodiments, a location request from a client may include accuracy requirements which include the following: 1) a response time (e.g., no delay, low delay, delay tolerant); 2) horizontal and/or vertical accuracy requirements (e.g., in meters); and/or 3) LCS quality of service (“QoS”) class (e.g., best effort, assured, and/or multiple QoS corresponding to a priority of QoS accuracy, LCS QoS class corresponding to pre-defined accuracy requirements).

In some embodiments, if the LMF 408 determines a location, the UE 402 also determines the accuracy of the location and whether the location accuracy requirements are met. In the response to the client, the LMF 408 includes information about whether the accuracy is met and, if not, provides the accuracy of the location measurement.

In various embodiments, a consumer (of location request) is enabled to be notified based on analytics about whether a measurement accuracy of a location is met.

In certain embodiments, a consumer (e.g., a location client) requests from NWDAF analytics “Location Measurement Accuracy”. The request may contain a specific analytic ID (e.g., “location measurement accuracy”) that enables the NWDAF to determine the analytics required and a data producer network function (“NF”) to collect data.

In some embodiments, a request may also include the following as analytic filters: 1) a target area; 2) a target UE, a group of UEs, and/or any UE; 3) a time of day; 4) a route corresponding to geographical points and/or a corresponding time of day for each geographical point; 5) an accuracy threshold (e.g., report location measurement accuracy analytics only if the accuracy drops below a certain threshold, report location measurement accuracy analytics only if the location measurement accuracy exceed an horizontal or a vertical accuracy threshold (e.g., in meters)); 6) report location measurement accuracy analytics for a specific measurement accuracy requirement (e.g., a location request with specific vertical measurement accuracy and/or horizontal measurement accuracy or specific LCS QOS requirements, if this indication is sent then the consumer requests analytics for location measurement accuracy if a consumer includes a minimum measurement accuracy (e.g., LCS QoS) requirement—the NWDAF provides statistics and/or prediction if the specific LCS QoS and/or measurement requirement can or cannot be guaranteed); and/or 7) a request may also include information whether a location measurement accuracy is sustainable in a target area and/or particular time period. The request may include a threshold (e.g., minimum measurement accuracy percentage requirement, provide statistics or a prediction if a measurement accuracy drops below 80% accuracy from a minimum required accuracy).

In various embodiments, if an NWDAF receives a request, the NWDAF determines that data needs to be collected by the LMF taking into account a consumer request. The NWDAF invokes a new service based interface (“SBI”) (e.g., Nlmf_Event_Exposure) and requests data from the LMF identified by a new event ID (e.g., “Location Measurement Accuracy request”). The LMF, based on the event ID requested, provides information on accuracy of a measurement of a location if a location measurement is made by the LMF.

In certain embodiments, data may be collected via an operations and maintenance (“OAM”) function. The LMF reports the location measurement accuracy information to the OAM and the NWDAF interfaces with the OAM to obtain location measurement accuracy data.

In some embodiments, a request from an NWDAF to a LMF to retrieve data may include the following information: 1) if a consumer included a request for analytics for location measurement accuracy for a specific measurement accuracy requirement, the NWDAF requests from the LMF to report location measurement accuracy data if a location measurement is made to satisfy a specific location measurement accuracy requirement request from a location client—the LMF provides a measurement report only for client requests that included the requested location measurement accuracy requirement (e.g., specific LCS QOS or specific vertical and/or horizontal accuracy); 2) a target area; 3) a target UE, a group of UEs, and/or any UE; 4) a time of day; and/or 5) a route corresponding to geographical points. If a route is included, the LMF tracks the route of the UE and reports the accuracy of measurements if the UE satisfies the route.

In various embodiments, an NWDAF collects data and derives statistics or predictions of location measurement accuracy. In certain embodiments, if a consumer includes a route in an analytics request, an NWDAF may additionally support the following: if a route is included in the analytics request, the NWDAF determines analytics only for UEs that satisfy the route. The NWDAF may request location information from an AMF or an LMF to track the route of the UE and derive accuracy analytics only if the route requirement is satisfied.

In some embodiments, if a consumer requests whether a location measurement accuracy is sustainable in a target area and/or a particular time period, the NWDAF may determine, in a target area and/or time period, a percentage of measurements that drop below a certain measurement accuracy level. If the threshold is crossed, the NWDAF reports the analytics to the consumer.

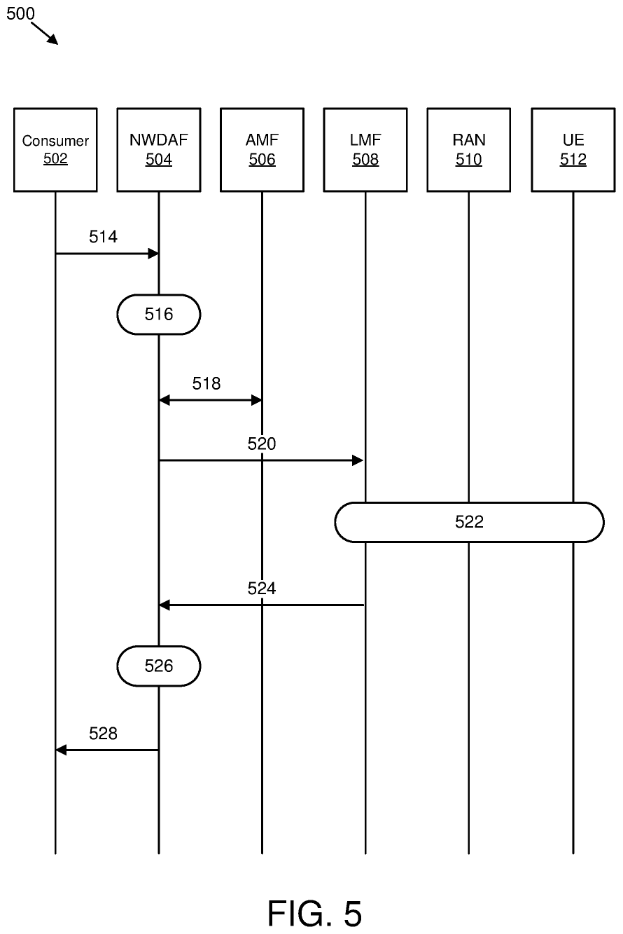

FIG. 5 is a schematic block diagram illustrating one embodiment of a system 500 for analyzing location measurement accuracy (e.g., procedure to derive analytics for location measurement accuracy). The system 500 includes a consumer 502, an NWDAF 504, an AMF 506, an LMF 508, a RAN 510, and a UE 512. Any of the communications described herein may include one or more messages.

In a first communication 514, the consumer 502 requests analytics for location measurement accuracy from the NWDAF 504. The request may include a target area, a time of day, a target UE (or group of UEs or any UE). The request may also include information about whether to report analytics for a specific measurement accuracy requirement (e.g., a specific LCS QoS or horizontal and/or vertical accuracy). The request may include a route corresponding to a list of geographical points (e.g., and corresponding time of day) where statistics on location accuracy are requested. The request may also include a request to predict waypoints and/or routes that offer the best location measurement accuracy (e.g., prescriptive request).

The NWDAF 504 finds 516 the LMF 508 serving the UE 512 (e.g., if a target UE is requested) or the LMF 508 serving a target area (e.g., if the request in step 514 is for any UE and a target area is included in the request).

In a second communication 518, either the NWDAF 504 finds the AMF 506 serving the UE 512 and requests the LMF 508 ID from the AMF 506 using a new service operation, or the NWDAF 504 discovers the LMF 508 from a network repository function (“NRF”).

In a third communication 520, the NWDAF 504 sends a request to the LMF 508 to provide location measurement accuracy data (e.g., the request may be a subscription or a one-time request). The request may be identified by a new event exposure event ID that allows the LMF 508 to determine to provide the accuracy of a location measurement if the LMF 508 makes a location measurement. The NWDAF 504 includes in the request to the LMF 508 information to satisfy the requirements of the consumer 502 in step 514. The NWDAF 504 includes in the request information based on the request in step 514, such as: 1) if the consumer 502 includes a request for location measurement accuracy analytics for a specific measurement accuracy requirement, the NWDAF 504 requests from the LMF 508 to report location measurement accuracy if a location measurement is made to satisfy a specific measurement accuracy requirement request from a location client—the LMF 508 provides a measurement report only for client requests that included the requested measurement accuracy requirement, such as including; 2) a target area; 3) a target UE, a group of UEs, and/or any UE; 4) a time of day; 5) a route corresponding to geographical points—if a route is included, the LMF 508 tracks the route of the UE 512 and reports the measurement accuracy if the UE satisfies the route; and/or 6) a request to predict a route between waypoints that offers best location measurement accuracy (e.g., a prescriptive request) to the NWDAF 504.

In a fourth communication 522, the LMF 508 calculates location measurement accuracy every time a location measurement of the UE 512 is made. If the request in step 524 includes a request for location measurement accuracy for a specific measurement accuracy requirement, the LMF 508 reports location measurement accuracy data if a location measurement is made to satisfy a specific measurement accuracy requirement request from a location client. Otherwise, the LMF 508 provides location measurement accuracy data every time a location measurement is made for any request (e.g., taking into account the target UE request in step 520).

In a fifth communication 524, the data is provided to the NWDAF 504.

The NWDAF 504 derives 526 analytics for accuracy based on the requested information in step 520.

In a sixth communication 528, the NWDAF 504 provides analytics to the consumer 502.

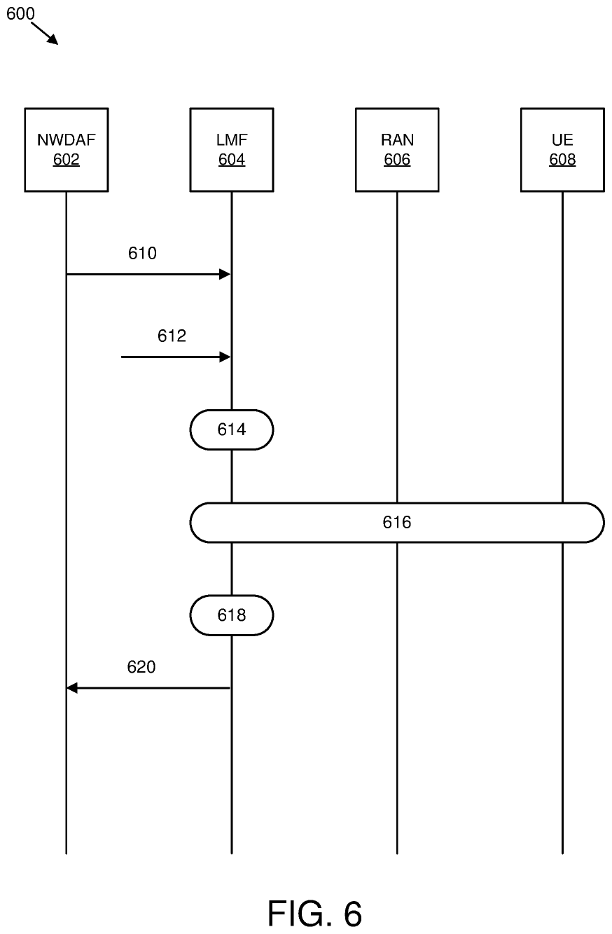

FIG. 6 is a schematic block diagram illustrating another embodiment of a system 600 for analyzing location measurement accuracy (e.g., LMF providing measurement accuracy information to NWDAF). The system 600 includes an NWDAF 602, an LMF 604, a RAN 606, and a UE 608. Any of the communications described herein may include one or more messages.

In a first communication 610, the NWDAF 602 sends a request to the LMF 604 to receive data indicating location measurement accuracy. The NWDAF 602 may include in the request a minimum requested measurement accuracy requirement. The NWDAF 602 may also include a list of UEs, a target area, and/or a time period.

In a second communication 612, the LMF 604 receives requests (e.g., from a location client, a GMLC, an AMF) to provide location measurements for a UE and/or a list of UEs.

The LMF 604 determines 614 if measurements of locations requested in step 612 satisfy the requirements of step 610.

In a third communication 616, the LMF 604 measures the location of a UE based on various procedures (e.g., predefined procedures).

The LMF 604 measures 618 the accuracy of the location and determines if the measurement accuracy needs to be reported to the NWDAF 602 (e.g., based on step 614).

In a fourth communication 620, the LMF 604 provides measurement data to the NWDAF 602. In various embodiments, analytics output to a consumer may include information based on information found in Table 1 and/or Table 2.

TABLE 1
“Location Measurement Accuracy” statistics

| Information | Description |
|---|---|
| List of Accuracy | |
| Analytics (1 . . . max) | |
| Applicable Area | A list of tracking area identifiers (“TAIs”) or cell |
| | IDs within the Location information that the |
| | analytics applies to. |
| Applicable Time | The time period within the Analytics target period |
| Period | that the analytics applies to. |
| The requested LCS | The analytics provide a delta against the request |
| QoS | measurement accuracy level from a consumer |
| List of subscription | A list of SUPIs experiencing the same analytics |
| permanent identifiers | accuracy |
| (“SUPIs”) | |
| Route | A route of the UE where accuracy of location is |
| | estimated |
| Percentage of | A percentage indicating if the requested analytics |
| analytics accuracy | accuracy is met |
| above/below requested | |
| thresholds | |

TABLE 2
“Location Measurement Accuracy” predictions

| Information | Description |
|---|---|
| List of Accuracy | |
| sustainability | |
| Analytics (1 . . . max) | |
| Applicable Area | A list of TAIs or cell IDs within the Location |
| | information that the analytics applies to. |
| Applicable Time | The time period within the Analytics target period |
| Period | that the analytics applies to. |
| The requested LCS | The analytics provide a delta against the request |
| QoS | measurement accuracy level from a consumer |
| List of SUPIs | A list of SUPIs experiencing the same analytics |
| | accuracy |
| Route | A route of a UE where accuracy of location is |
| | predicted (If route is included the accuracy |
| | sustainability analytics are valid for the route of |
| | UE or list of UEs if a list of SUPIs is included.) |
| Percentage of | A percentage prediction indicating if the |
| analytics accuracy | requested analytics accuracy is met |
| above/below requested | |
| thresholds | |
| Confidence | Confidence of the prediction. |

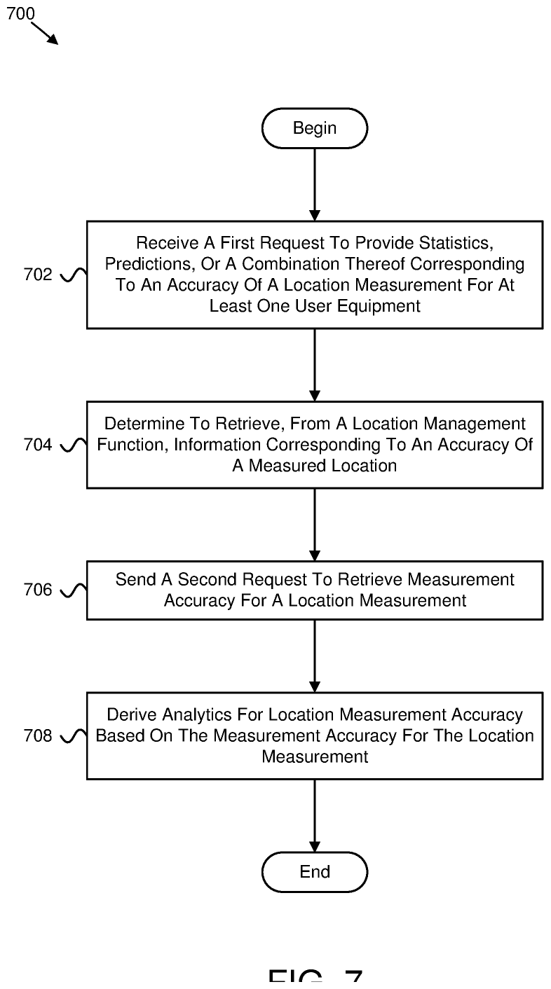

FIG. 7 is a flow chart diagram illustrating one embodiment of a method 700 for analyzing location measurement accuracy. In some embodiments, the method 700 is performed by an apparatus, such as the network unit 104 (e.g., network data analytics function). In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a network data analytics function, a first request to provide statistics, predictions, or a combination thereof corresponding to an accuracy of a location measurement for at least one user equipment. In some embodiments, the method 700 includes determining 704 to retrieve, from a location management function, information corresponding to an accuracy of a measured location. In certain embodiments, the method 700 includes sending 706 a second request to retrieve measurement accuracy for a location measurement. In various embodiments, the method 700 includes deriving 708 analytics for location measurement accuracy based on the measurement accuracy for the location measurement.

In certain embodiments, the first request comprises a route for the at least one user equipment. In some embodiments, the method 700 further comprises determining to retrieve location data to track the route of the at least one use equipment and deriving accuracy analytics in response to a route requirement being satisfied. In various embodiments, the route corresponds to a list of geographical points and a corresponding time period.

In one embodiment, the first request comprises a target area and a period of time for requesting analytics. In certain embodiments, the first request comprises minimum requested quality of service information for providing a location measurement. In some embodiments, the method 700 further comprises deriving analytics only for location measurements made using the minimum requested quality of service information.

In various embodiments, the method 700 further comprises transmitting information indicating to only report location measurements made using the minimum requested quality of service information. In one embodiment, the first request comprises a request to identify whether the accuracy of the measured location is sustainable. In certain embodiments, the minimum requested quality of service information comprises a horizontal accuracy requirement, a vertical accuracy requirement, a response time, a quality of service class, or some combination thereof. In some embodiments, determining to retrieve the information corresponding to the accuracy of the measured location comprises retrieving the accuracy of the measured location from an operations and maintenance function.

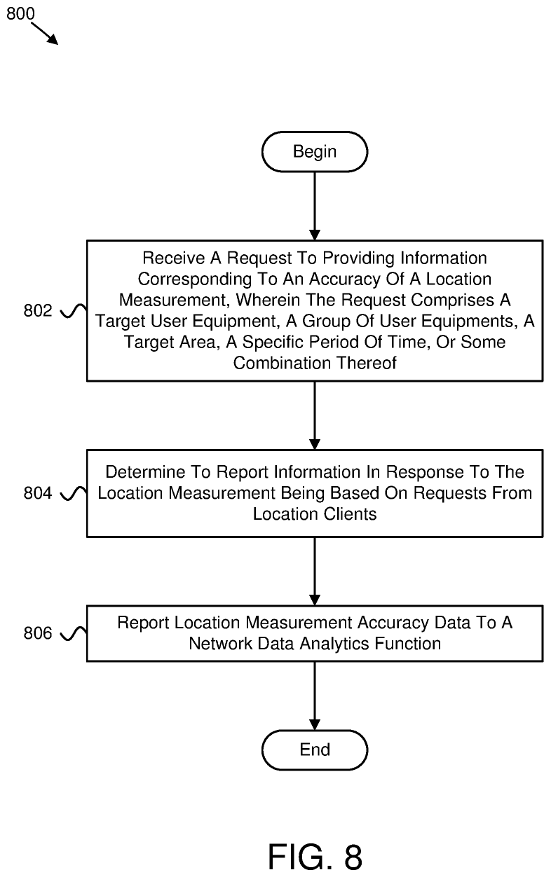

FIG. 8 is a flow chart diagram illustrating another embodiment of a method 800 for analyzing location measurement accuracy. In some embodiments, the method 800 is performed by an apparatus, such as the network unit 104 (e.g., location management function). In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at a location management function, a request to providing information corresponding to an accuracy of a location measurement. The request includes a target user equipment, a group of user equipments, a target area, a specific period of time, or some combination thereof. In some embodiments, the method 800 includes determining 804 to report information in response to the location measurement being based on requests from location clients. In certain embodiments, the method 800 includes reporting 806 location measurement accuracy data to a network data analytics function.

In certain embodiments, the request comprises requested quality of service information for providing a location measurement. In some embodiments, the method 800 further comprises determining to report an accuracy of location measurements for requests for the location measurements comprising the requested quality of service information. In various embodiments, the minimum requested quality of service information comprises a horizontal accuracy requirement, a vertical accuracy requirement, a response time, a quality of service class, or some combination thereof.

In one embodiment, a method of a network data analytics function comprises: receiving a first request to provide statistics, predictions, or a combination thereof corresponding to an accuracy of a location measurement for at least one user equipment; determining to retrieve, from a location management function, information corresponding to an accuracy of a measured location; sending a second request to retrieve measurement accuracy for a location measurement; and deriving analytics for location measurement accuracy based on the measurement accuracy for the location measurement.

In certain embodiments, the first request comprises a route for the at least one user equipment.

In some embodiments, the method further comprises determining to retrieve location data to track the route of the at least one use equipment and deriving accuracy analytics in response to a route requirement being satisfied.

In various embodiments, the route corresponds to a list of geographical points and a corresponding time period.

In one embodiment, the first request comprises a target area and a period of time for requesting analytics.

In certain embodiments, the first request comprises minimum requested quality of service information for providing a location measurement.

In some embodiments, the method further comprises deriving analytics only for location measurements made using the minimum requested quality of service information.

In various embodiments, the method further comprises transmitting information indicating to only report location measurements made using the minimum requested quality of service information.

In one embodiment, the first request comprises a request to identify whether the accuracy of the measured location is sustainable.

In certain embodiments, the minimum requested quality of service information comprises a horizontal accuracy requirement, a vertical accuracy requirement, a response time, a quality of service class, or some combination thereof.

In some embodiments, determining to retrieve the information corresponding to the accuracy of the measured location comprises retrieving the accuracy of the measured location from an operations and maintenance function.

In one embodiment, an apparatus comprises a network data analytics function. The apparatus further comprises: a receiver that receives a first request to provide statistics, predictions, or a combination thereof corresponding to an accuracy of a location measurement for at least one user equipment; and a processor that: determines to retrieve, from a location management function, information corresponding to an accuracy of a measured location; sends a second request to retrieve measurement accuracy for a location measurement; and derives analytics for location measurement accuracy based on the measurement accuracy for the location measurement.

In certain embodiments, the first request comprises a route for the at least one user equipment.

In some embodiments, the processor determines to retrieve location data to track the route of the at least one use equipment and deriving accuracy analytics in response to a route requirement being satisfied.

In various embodiments, the route corresponds to a list of geographical points and a corresponding time period.

In one embodiment, the first request comprises a target area and a period of time for requesting analytics.

In certain embodiments, the first request comprises minimum requested quality of service information for providing a location measurement.

In some embodiments, the processor derives analytics only for location measurements made using the minimum requested quality of service information.

In various embodiments, the apparatus further comprises a transmitter that transmits information indicating to only report location measurements made using the minimum requested quality of service information.

In one embodiment, the first request comprises a request to identify whether the accuracy of the measured location is sustainable.

In certain embodiments, the minimum requested quality of service information comprises a horizontal accuracy requirement, a vertical accuracy requirement, a response time, a quality of service class, or some combination thereof.

In some embodiments, the processor determining to retrieve the information corresponding to the accuracy of the measured location comprises the processor retrieving the accuracy of the measured location from an operations and maintenance function.

In one embodiment, a method of a location management function comprises: receiving a request to providing information corresponding to an accuracy of a location measurement, wherein the request comprises a target user equipment, a group of user equipments, a target area, a specific period of time, or some combination thereof; determining to report information in response to the location measurement being based on requests from location clients; and reporting location measurement accuracy data to a network data analytics function.

In certain embodiments, the request comprises requested quality of service information for providing a location measurement.

In some embodiments, the method further comprises determining to report an accuracy of location measurements for requests for the location measurements comprising the requested quality of service information.

In various embodiments, the minimum requested quality of service information comprises a horizontal accuracy requirement, a vertical accuracy requirement, a response time, a quality of service class, or some combination thereof.

In one embodiment, an apparatus comprises a location management function. The apparatus further comprises: a receiver that receives a request to providing information corresponding to an accuracy of a location measurement, wherein the request comprises a target user equipment, a group of user equipments, a target area, a specific period of time, or some combination thereof; and a processor that: determines to report information in response to the location measurement being based on requests from location clients; and reports location measurement accuracy data to a network data analytics function.

In certain embodiments, the request comprises requested quality of service information for providing a location measurement.

In some embodiments, the processor determines to report an accuracy of location measurements for requests for the location measurements comprising the requested quality of service information.

In various embodiments, the minimum requested quality of service information comprises a horizontal accuracy requirement, a vertical accuracy requirement, a response time, a quality of service class, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a network data analytics function, the method comprising:
receiving a first request to provide statistics, predictions, or a combination thereof corresponding to an accuracy of a location measurement for at least one user equipment (UE);
determining to retrieve, from a location management function, information corresponding to an accuracy of a measured location;
sending a second request to retrieve measurement accuracy for a location measurement; and
deriving analytics for location measurement accuracy based on the measurement accuracy for the location measurement.

2. An apparatus for performing a network function, the apparatus further comprising:
at least one memory; and
at least one processor coupled with the at least one memory and configured to cause the apparatus to:
receive a first request to provide statistics, predictions, or a combination thereof corresponding to an accuracy of a location measurement for at least one user equipment (UE);
determine to retrieve, from a location management function, information corresponding to an accuracy of a measured location;
send a second request to retrieve measurement accuracy for a location measurement; and
derive analytics for location measurement accuracy based on the measurement accuracy for the location measurement.

3. The apparatus of claim 2, wherein the first request comprises a route for the at least one UE.

4. The apparatus of claim 3, wherein the at least one processor is configured to cause the apparatus to determine to retrieve location data to track the route of the at least one UE and deriving accuracy analytics in response to a route requirement being satisfied.

5. The apparatus of claim 3, wherein the route corresponds to a list of geographical points and a corresponding time period.

6. The apparatus of claim 2, wherein the first request comprises a target area and a period of time for requesting analytics.

7. The apparatus of claim 2, wherein the first request comprises minimum requested quality of service (QOS) information for providing a location measurement.

8. The apparatus of claim 7, wherein the at least one processor is configured to cause the apparatus to derive analytics only for location measurements made using the minimum requested QoS information.

9. The apparatus of claim 8, wherein the at least one processor is configured to cause the apparatus to transmit information indicating to only report location measurements made using the minimum requested QoS information.

10. The apparatus of claim 7, wherein the minimum requested QoS information comprises a horizontal accuracy requirement, a vertical accuracy requirement, a response time, a QoS class, or a combination thereof.

11. The apparatus of claim 2, wherein the first request comprises a request to identify whether the accuracy of the measured location is sustainable.

12. The apparatus of claim 2, wherein the at least one processor is configured to cause the apparatus to determine to retrieve the information corresponding to the accuracy of the measured location comprises the processor retrieving the accuracy of the measured location from an operations and maintenance function.

13. An apparatus for performing a network function, the apparatus further comprising:
at least one memory; and
at least one processor coupled with the at least one memory and configured to cause the apparatus to:
receive a request to provide information corresponding to an accuracy of a location measurement, wherein
the request comprises a target user equipment (UE), a group of UEs, a target area, a specific period of time, or a combination thereof;
determine to report information in response to the location measurement being based on requests from location clients; and
report location measurement accuracy data to a network data analytics function.

14. The apparatus of claim 13, wherein the request comprises requested quality of service (QOS) information for providing a location measurement.

15. The apparatus of claim 14, wherein the at least one processor is configured to cause the apparatus to determine to report an accuracy of location measurements for requests for the location measurements comprising the requested QoS information.

16. A method of performing a network function, the method comprising:
receiving a request to provide information corresponding to an accuracy of a location measurement, wherein the request comprises a target user equipment (UE), a group of UEs, a target area, a specific period of time, or a combination thereof;
determining to report information in response to the location measurement being based on requests from location clients; and
reporting location measurement accuracy data to a network data analytics function.

17. The method of claim 16, wherein the request comprises requested quality of service (QOS) information for providing a location measurement.

18. The method of claim 17, further comprising determining to report an accuracy of location measurements for requests for the location measurements comprising the requested QoS information.

19. The method of claim 16, wherein the first request comprises a route for the at least one UE.

20. The method of claim 19, further comprising determining to retrieve location data to track the route of the at least one UE and deriving accuracy analytics in response to a route requirement being satisfied.
